(19) United States
(12) Patent Application Publication
(10) Pub. No.: US 2009/0213408 A1
(43) Pub. Date: Aug. 27, 2009

(54) Print Controlling Device, Method to Control Printing, and a Computer Usable Medium Therefor

(75) Inventor: Yuji MIYATA, Nagoya (JP)

Correspondence Address: BANNER & WITCOFF, LTD.;ATTORNEYS FOR CLIENT NO. 016689, 1100 13th STREET, N.W., SUITE 1200, WASHINGTON, DC, 20005-4051, US

(73) Assignee: BROTHER KOGYO KABUSHIKI KAISHA, Nagoya (JP)

(21) Appl. No.: 12/389,566

(22) Filed: Feb. 20, 2009

(30) Foreign Application Priority Data
Feb. 22, 2008 (JP) 2008-041368

(51) Int. Cl. G06F 3/12

(52) U.S. Cl. 358/1.13

(57) ABSTRACT

A print controlling device operated on a multi-task operating system to process application data according to a printer driver is provided. The print controlling device includes an input device, a display device, a modifying system to modify the application data into a printable format, a communication interface, an output device determining system to determine to which devices between the printing device and the display device the printable-formatted data is output, an activating system to activate a displaying program in a separated operating task from the currently-executed operating task having been executed for the printer driver, a transmission system to transmit the printable-formatted data to the printing device, and a terminating system to terminate the currently-running operating task for the printer driver when the activating system activates the displaying program in the separated operating task.

### CROSS REFERENCE TO RELATED APPLICATION

This application claims priority from Japanese Patent Application No. 2008-041368, filed on Feb. 22, 2008, the entire subject matter of which is incorporated herein by reference.

### BACKGROUND

1. Technical Field

Aspects of the present invention relate to a computer and an apparatus to control a printing operation and a computer usable medium to be used in the computer and the apparatus.

2. Related Art

A method to display a print preview image, which represents an image to be printed in a printing apparatus prior to an actual printing operation, on a monitor device of a data processing apparatus has been known. Such a method is disclosed in, for example, Japanese Patent Provisional Publication No. H07-325693. According to the disclosure, displaying the print preview image is achieved according to a program to process preview images included in a printer driver, which is installed in the data processing apparatus. Therefore, even when an application program to run in the data processing apparatus lacks a specific function to display a print preview image, the print preview image can be displayed.

### SUMMARY

However, in a computer being operated by an operating system such as Windows (registered trademark), a printer driver to be called by the application program runs to be included in a currently-running operation task of the application program. Therefore, a preceding process for the interrupted application program is paused while the printer driver runs active, and a user's input to manipulate the application program cannot be accepted. Accordingly, when a preview image is displayed by the printer driver on the monitor, the inputting operations by the user who may wish to have an original image generated by the application program to be displayed simultaneously with the preview image on a screen of the monitor for comparison cannot be accepted.

In view of the above drawback, the present invention is advantageous in that a computer and a printing apparatus, which are capable of displaying the preview image along with the original image generated by the application program at one time, and a computer usable medium to control the computer and the printing apparatus, are provided.

According to an aspect of the invention, a print controlling device operated on a multi-task operating system to process application data according to a printer driver, is provided. The printer driver is activated by the application program to be included in a currently-running operating task having executed a preceding process for the application program, whilst the preceding process for the application program in the currently-running operation task is paused. The print controlling device includes an input device to input information to be processed in the print controlling device, a display device to display the information inputted in the print controlling device, a modifying system to modify the application data into a printable format, a communication interface through which the printable-formatted data is transmitted to a printing device so that the image represented by the application data is printed, an output device determining system to determine to which devices between the printing device and the display device the printable-formatted data is output, an activating system to activate a displaying program in a separated operating task from the currently-executed operating task having been executed for the printer driver when the display device is selected by the output device determining system, a transmission system to transmit the printable-formatted data to the printing device when the printing device is selected by the output device determining system, and a terminating system to terminate the currently-running operating task for the printer driver when the activating system activates the displaying program in the separated operating task.

According to another aspect of the invention, a method to control a computer operated on a multi-task operating system to process application data according to a printer driver is provided. The printer driver is activated by the application program to be included in a currently-running operating task having executed a preceding process for the application program, whilst the preceding process for the application program in the currently-running operation task is paused. The method includes converting the application data into a printable format, determining to which devices between a printing device and a display device, which are connected with the computer, the printable-formatted data is output, activating a displaying program in a separated operating task from the currently-executed operating task having been executed for the printer driver when the display device is determined to be the one to which the printable-formatted data is output, transmitting the printable-formatted data to the printing device when the printing device is s determined to be the one to which the printable-formatted data is output, and terminating the currently-running operating task for the printer driver when the displaying program is activated in the separated operating task.

According to still another aspect of the invention, a computer usable medium including computer readable instructions to control a computer operated on a multi-task operating system to process application data according to a printer driver is provided. The printer driver is activated by the application program to be included in a currently-running operating task having executed a preceding process for the application program, whilst the preceding process for the application program in the currently-running operation task is paused. The computer readable instructions controls the computer by executing steps of converting the application data into a printable format, determining to which devices between a printing device and a display device, which are connected with the computer, the printable-formatted data is output, activating a displaying program in a separated operating task from the currently-executed operating task having been executed for the printer driver when the display device is determined to be the one to which the printable-formatted data is output, transmitting the printable-formatted data to the printing device when the printing device is s determined to be the one to which the printable-formatted data is output, and terminating the currently-running operating task for the printer driver when the displaying program is activated in the separated operating task.

According to still another aspect of the invention, a method to control a print preparing operation according to a print preparation program, which includes a printer driver and a displaying program, in a computer operated on a multi-task operating system to process application data according to the printer driver, is provided. The printer driver is activated by the application program to be included in a currently-running operating task having executed a preceding process for the application program, whilst the preceding process for the application program in the currently-running operation task is paused. The printer driver includes steps of converting the application data into a printable format, determining to which devices between a printing device and a display device, which are connected with the computer, the printable-formatted data is output, activating the displaying program in a separated operating task from the currently-executed operating task having been executed for the printer driver when the display device is determined to be the one to which the printable-formatted data is output, transmitting the printable-formatted data to the printing device when the printing device is s determined to be the one to which the printable-formatted data is output, and terminating the currently-running operating task for the printer driver when the displaying program is activated in the separated operating task. The displaying program is configured to display the printable-formatted data in the display device to present a preview image, which represents an image to be printed by the printing device.

According to still another aspect of the invention, a computer usable medium comprising computer readable instructions to control a print preparing operation according to a print preparation program, which includes a printer driver and a displaying program, in a computer operated on a multi-task operating system to process application data according to the printer driver, is provided. The printer driver is activated by the application program to be included in a currently-running operating task having executed a preceding process for the application program, whilst the preceding process for the application program in the currently-running operation task is paused. The printer driver includes steps of converting the application data into a printable format, determining to which devices between a printing device and a display device, which are connected with the computer, the printable-formatted data is output, activating the displaying program in a separated operating task from the currently-executed operating task having been executed for the printer driver when the display device is determined to be the one to which the printable-formatted data is output, transmitting the printable-formatted data to the printing device when the printing device is s determined to be the one to which the printable-formatted data is output, and terminating the currently-running operating task for the printer driver when the displaying program is activated in the separated operating task. The displaying program is configured to display the printable-formatted data in the display device to present a preview image, which represents an image to be printed by the printing device.

According to the above configurations, the print controlling device terminates the printer driver after activation of the displaying program in the separated operating task so that a preview image and an image created in the application program can be simultaneously displayed. Therefore, even in a computer configured such that the preceding process for the activating application program which activated the printer driver is paused until the process for the printer driver completes, the printer driver can be terminated so that the paused process for the application program can be resumed whilst the preview image is displayed.

### BRIEF DESCRIPTION OF THE ACCOMPANYING DRAWINGS

FIG. 1 is a block diagram to illustrate a printer 10 and a PC 30 according to an embodiment of the present invention.

FIG. 2 is a flowchart to illustrate a print preparation process to be executed in the PC 30 according to the embodiment of the present invention.

FIG. 3 is a flowchart to illustrate a watermark applying process to be executed in the PC 30 according to the embodiment of the present invention.

FIG. 4 is a flowchart to illustrate an output-determination process to be executed in the PC 30 according to the embodiment of the present invention.

FIG. 5 is a flowchart to illustrate a preview displaying process to be executed in the PC 30 according to the embodiment of the present invention.

FIG. 6 illustrates a print preview image to be displayed according to the embodiment of the present invention.

FIGS. 7A and 7B are diagrams to illustrate a relationship between an operation task and a preview displaying task according to the embodiment of the present invention.

### DETAILED DESCRIPTION

Hereinafter, an embodiment according to an aspect of the present invention will be described with reference to the accompanying drawings.

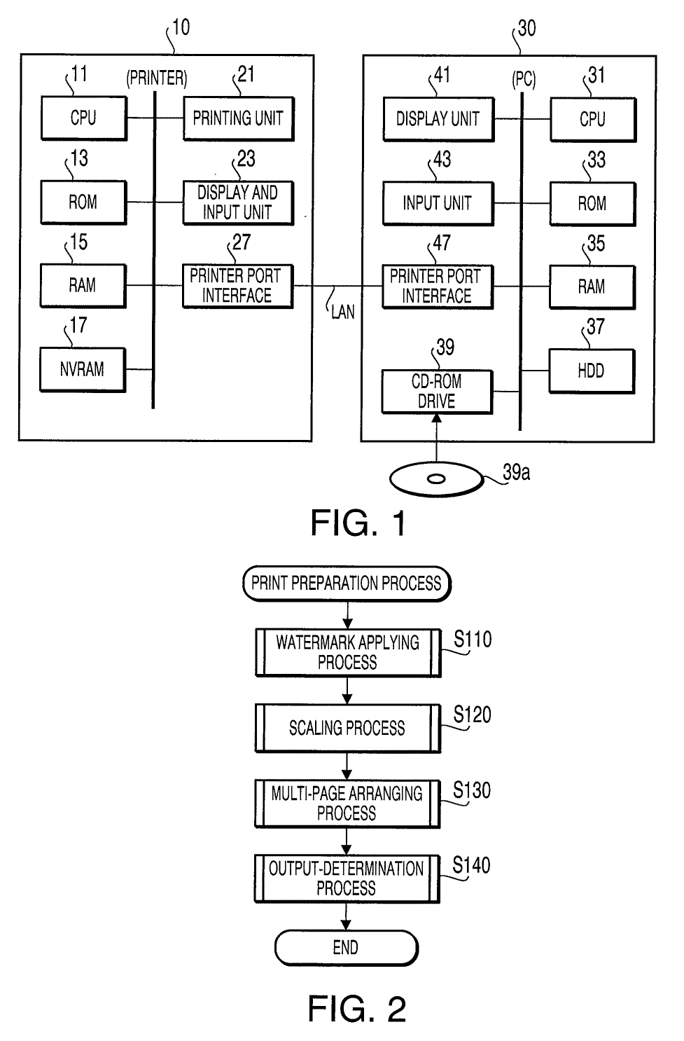

FIG. 1 is a block diagram to illustrate a printer 10 and a PC (personal computer) 30 to control the printer 10 according to the embodiment of the present invention. The printer 10 is equipped with a CPU 11, a ROM 13, a RAM 15, an NVRAM (non-volatile RAM) 17, a printing unit 21, a display and input unit 23, and a printer port interface 27. The CPU 11 executes programs to control entire behaviors of the other components included in the printer 10. The programs to be executed by the CPU 11 are stored in the ROM 13. The RAM 15 is a work area to be used to run various programs. The NVRAM 17 is a rewritable memory to temporarily store various data to be used in the programs. The printing unit 21 is operated to print an image according to a print job data, which is transmitted from the PC 30. The display and input unit 23 includes a display screen (e.g., an LCD (liquid crystal display)) and an input device (e.g., keys) which can be operated by a user to manipulate the operations in the printer 10. The printer port interface 27 being a LAN interface is connected to a LAN so that various data can be exchanged between the printer 10 and the PC 30.

The PC 30 is equipped with a CPU 31, a ROM 33, a RAM 35, an HDD (hard disk drive) 37, a display unit 41, an input unit 43, and a printer port interface 47. The CPU 31 executes programs to control entire behaviors of the other components included in the PC 30. The programs to be executed by the CPU 31 to boot the PC 30 are stored in the ROM 33. The RAM 35 is a work area to be used to run various programs. The HDD 37 is a storage unit to store various programs such as a printer driver and various data to be used in application programs. The HDD 37 further stores a multi-task OS (e.g., Windows (registered trademark)) which can execute a plurality of tasks simultaneously in parallel. Execution of the plurality of tasks are controlled by the CPU 31 according to the multi-task OS. The display unit 41 includes a display screen (e.g., an LCD) to display various information to be processed in the PC 30. The printer port interface 47 being a LAN interface is connected to the LAN so that various data can be exchanged between the printer 10 and the PC 30.

The printer driver according to the present embodiment is a so-called DLL (Dynamic Link Library), which is a program component to be shared by a plurality of application programs to drive the printer 10 so that application data, created in an application program and representing an image to be printed, is passed to the printer 10 and printed to form the image. Therefore, when the user inputs an instruction to print an image, which is generated in an application program running on the multi-task OS, the printer driver is called and activated by the application program. A process according to the activated printer driver is included in a currently-executed operation task of the application program, which has called the printer driver, to be executed by the CPU 31. Thus, a preceding process to be executed for the application program is paused until the included process for the printer driver in the inclusive operation task completes.

The PC 30 further includes a CD-ROM drive 39 for reading data from a removable medium which is a CD-ROM 39a inserted therein. The CD-ROM 39a stores data including the printer driver. The data in the CD-ROM 39a is read by the CD-ROM drive 39 and stored in predetermined areas in the HDD 37.

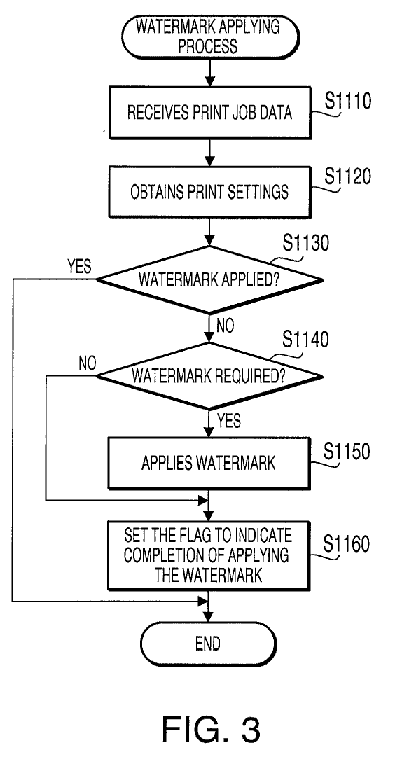

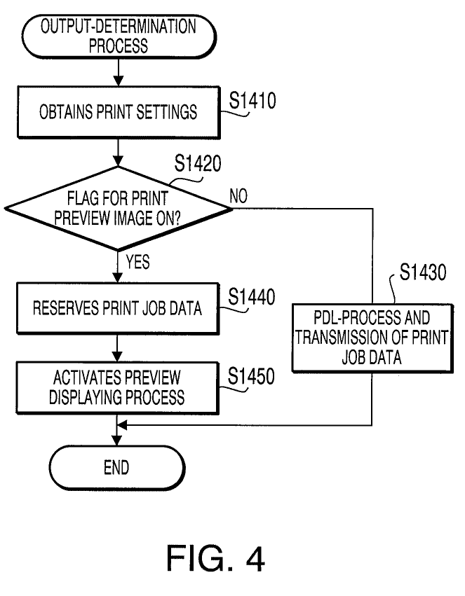

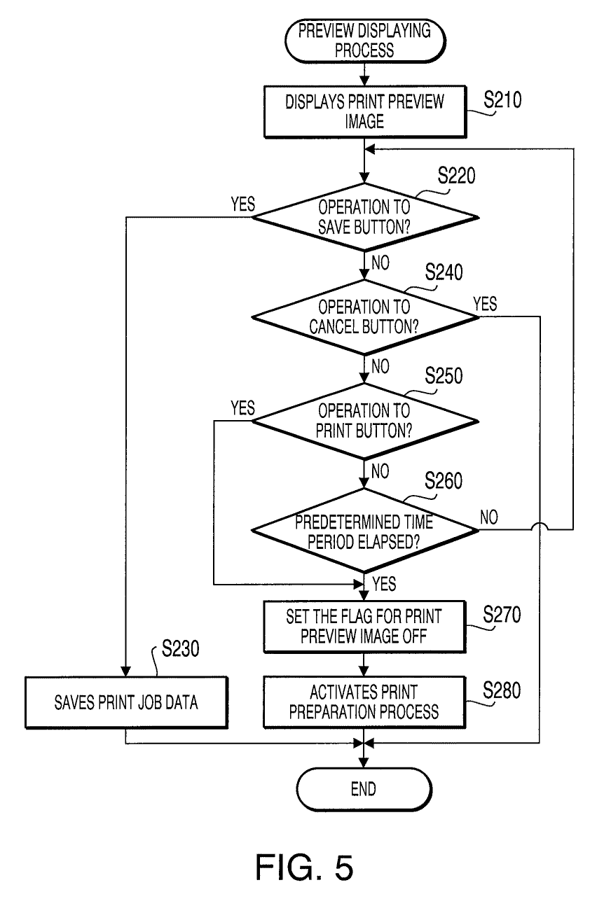

Next, a print preparation process to be executed in the PC 30 will be described with reference to FIG. 2 is a flowchart to illustrate the print preparation process to be executed in the PC 30 according to the embodiment of the present invention. FIG. 3 is a flowchart to illustrate a watermark applying process to be executed in the PC 30 according to the embodiment of the present invention. FIG. 4 is a flowchart to illustrate an output-determination process to be executed in the PC 30 according to the embodiment of the present invention. FIG. 5 is a flowchart to illustrate a preview displaying process to be executed in the PC 30 according to the embodiment of the present invention.

The print preparation process is activated when a print instruction is entered by the user through the input unit 43 and executed in the PC 30. As has been described above, when the print preparation process is performed by the CPU 31, a process dedicated to run for the application program is paused. When the print preparation process starts, in S110, a watermark applying process as shown in FIG. 3 is activated.

In the watermark applying process, application data, which represents an image to be printed, is modified into a printable format. In S110, the CPU 31 receives a print job data provided by the application program. The print job data includes application data and information concerning print settings for printing the application data. In S1120, the CPU 31 obtains the print settings included in the print job data. The print settings include flags to indicate completion/incompletion of a watermark applying process, a scaling process, and a multi-page arranging process respectively and a flag being an indication for displaying a preview image.

In S1130, the CPU 31 examines to judge as to whether the flag to indicate completion of the watermark applying process is set. When the print job data is firstly processed through the watermark applying process, the flag is not set. However, it is to be noted that watermark applying process can be repeated to process the once-processed print job data. Therefore, examination in S1130 is provided so that a watermark is not redundantly applied to the same application data.

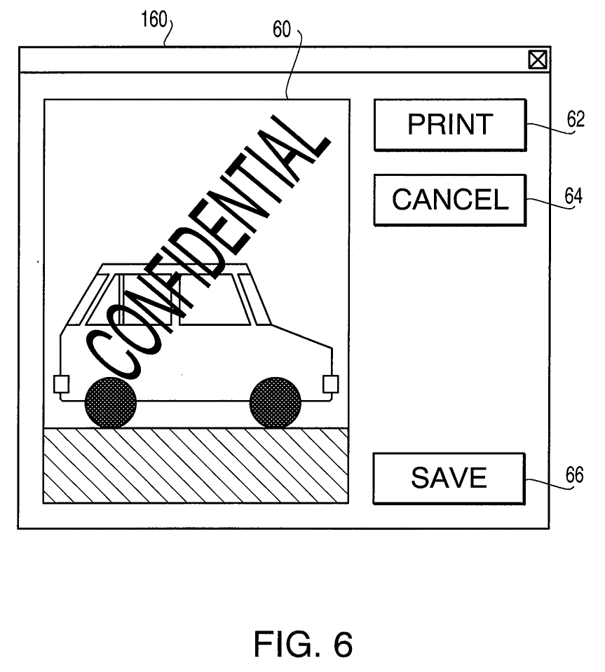

In S1130, if the flag is set (S1130: YES), it is determined that the watermark has been applied. Accordingly, the watermark applying process is terminated. If the flag is not set (S1130: NO), in S1140, the CPU 31 examines to judge as to whether a watermark is required to be applied to the application data based on the print settings obtained in S1120. If no watermark is required (S1140: NO), the CPU 31 proceeds to S1160. If a watermark is required (S1140: YES), in S1150, a watermark as specified by the print settings obtained in S1120 is applied to the application data so that the watermark is printed over the image on a recording sheet when the image is printed. In the present embodiment, a watermark being a character string “CONFIDENTIAL” is overlaid (see FIG. 6). The CPU 31 proceeds to S1160. In S1160, the flag to indicate completion of applying the watermark is set in the print job data. The watermark applying process is terminated thereafter, and the CPU 31 returns to the print preparation process shown in FIG. 2.

Following S110, in S120, a scaling process is applied to the print job data, which has been processed through the watermark applying process. The scaling process is to modify a printing magnification of the image to be printed. For example, the scaling is modified when an image to be fitted into an A4-size (297 mm×210 mm) is magnified to be fitted into an A3-size (420 mm×297 mm).

The scaling process is performed similarly to the watermark applying process shown in FIG. 3; therefore, detailed description of the scaling process is omitted herein. In this regard, however, it is noted that the terms “watermark applying process” is replaced with “scaling process,” and “applying a watermark” with “scaling.”

Following S120, in S130, a multi-page arranging process is applied to the print job data, which has been processed through the scaling process. The multi-page arranging process is to modify the print job data to arrange a plurality of pages of images to be fitted in a single page of recording sheet. The multi-page arranging process is performed similarly to the watermark applying process shown in FIG. 3; therefore, detailed description of the multi-page arranging process is omitted herein. In this regard, however, it is noted that the terms “watermark applying process” is replaced with “multi-page arranging process,” and “applying a watermark” with “arranging a plurality of pages in a single page.”

Following S130, in S140, an output-determination process is applied to the print job data, which has been processed through the multi-page arranging process. In the output-determination process, one of two options, which are activation of a preview displaying process and transmission of PDL (Page Description Language)-processed print job data, is selected to be executed. When the preview displaying process, which will be described later in detail, is activated, a print preview image is displayed on the screen of the display unit 41. The PDL process is a process to generate printer-supportive data to interpret contents of the printing operation to the printer 10 when the print instruction is given to the printer 10.

The output-determination process in S140 will be described with reference to FIG. 4. Once the output-determination process starts, in 1410, the print settings included in the print job data are obtained. In S1420, it is examined as to whether the flag being an indication for displaying a preview image is set in the print settings. It is to be noted that the flag is set ON prior to activation of the print preparation process when the user enters the print instruction through the input unit 43 and instructs to display the print preview image.

If the flag is not set (S1420: NO), in S1430, the print job data is PDL-processed and transmitted to the printer 10 through the printer port interface 47. The print preparation process is terminated thereafter.

In S1420, if the flag for the print preview image is set (S1420: YES), in S1440, the print job data is reserved in the RAM 35. In S1450, a preview displaying process is activated in a new operation task which is separated from the currently-executed operation task of the print preparation process. Thus, the preview displaying process can be performed in parallel with the print preparation process. Thereafter; the output-determination process is terminated, and the print preparation process shown in FIG. 2 is terminated.

When the print preparation process according to the printer driver is in progress, a process dedicated for the current application program is paused until the print preparation process completes. In other words, the CPU 31 is released to execute the process dedicated for the application program after completion of the print preparation process.

Next, the preview displaying process, which is activated in S1450 in the above-described output-determination process, will be described with reference to FIG. 5. The preview displaying process is executed by the CPU 31 according to a preview displaying program stored in the predetermined area of the HDD 37. It is to be noted that the preview displaying process is executed in an operation task separated from the current operation task executed in the application program which has called the printer driver. Therefore, a process to be executed for the application program is not paused even during the preview displaying process.

When the preview displaying process starts, in S210, a print preview image 60 is displayed on the screen of the display unit 41. The print preview image 60 represents an image to be printed by the printer 10 according to the application data, which has been processed through S110-S130 in FIG. 2. The print preview image 60 to be displayed on a preview window 160 in the screen of the display unit 41 is illustrated in FIG. 6. In addition to the print preview image 60, the preview window 160 includes the print preview image 60, a print button 62, a cancel button 64, and a save button 66, which can be operated by the user through the input unit 43.

When the preview window 160 is displayed, further, a timer is activated. Thereafter, in S220, it is examined as to whether the save button 66 has been operated. If the save button 66 has been operated (S220: YES), in S230, the print job data processed through S110-S130 is saved in a predetermined area of the HDD 37 according to a predetermined file format (e.g., TIFF format, PDF format, etc.). The print job data saved in the HDD 37 in S230 can be processed through in the print preparation process shown in FIG. 2.

In S220, if the save button 66 has not been operated (S220: NO), in S240, it is examined as to whether the cancel button 64 has been operated. When the cancel button 64 has been operated (S240: YES), the preview displaying process is terminated.

In S240, if the cancel button 64 has not been operated (S240: NO), in S250, it is examined as to whether the print button 62 has been operated. If the print button 62 has been operated (S250: YES), the process proceeds to S270. If the print button 62 has not been operated (S250: NO), in S260, it is examined as to whether a predetermined time period has elapsed based on the timer activated in S210. If the predetermined time period has not been elapsed (S260: NO), the process returns to S220. When the predetermine time period has elapsed (S260: YES), the process proceeds to S270.

Thus, when none of the print button 62, the cancel button 64, and the save button 66 has been operated, the CPU 31 waits for input until the predetermined time period elapses. When the predetermined time period elapses, the process proceeds to S270, in which the flag being the indication to display the print preview image is set OFF. Thereafter, in S280, the print preparation process is activated. The preview displaying process is terminated thereafter. According to the above configuration, when the user believes that he/she has operated the print button 62 (but actually he/she has not operated the print button 62) and waits for the printed image to be output by the printer 10, the image according to the current print job data is output anyway by the printer 10 so that the user should not be kept waiting for the image to be output by the printer 10 to waste time.

It is to be noted that the multi-task OS according to the present embodiment is configured such that the print preparation process according to the printer driver is activated in the current operation task of the activating application program. Therefore, the preview displaying program being the activating application program activates the print preparation process in the separated operation task.

When the print preparation process is activated in S280, the CPU 31 makes affirmative judgment in S1130 (S1130: YES) and negative judgment in S1420 (S1420: NO) in order for the print preview data is displayed. In other words, the flag is set ON and OFF in S1160 and S270 respectively in order to make such judgment so that the print preparation process can be reactivated in S280. Thus, the PDL-processed print job data is transmitted to the printer 10 in S1430 while the watermark applying process (S1150) can be avoided from being applied redundantly to once-applied application data, and activation of the preview displaying process can be avoided after the application data in the print job data is printed.

Therefore, when the print preparation process is activated in S280, the print job data including the application data, of which preview image was displayed in S210, is PDL-processed and transmitted to the printer 10 so that an image represented by the print preview image 60 is printed in the printer 10.

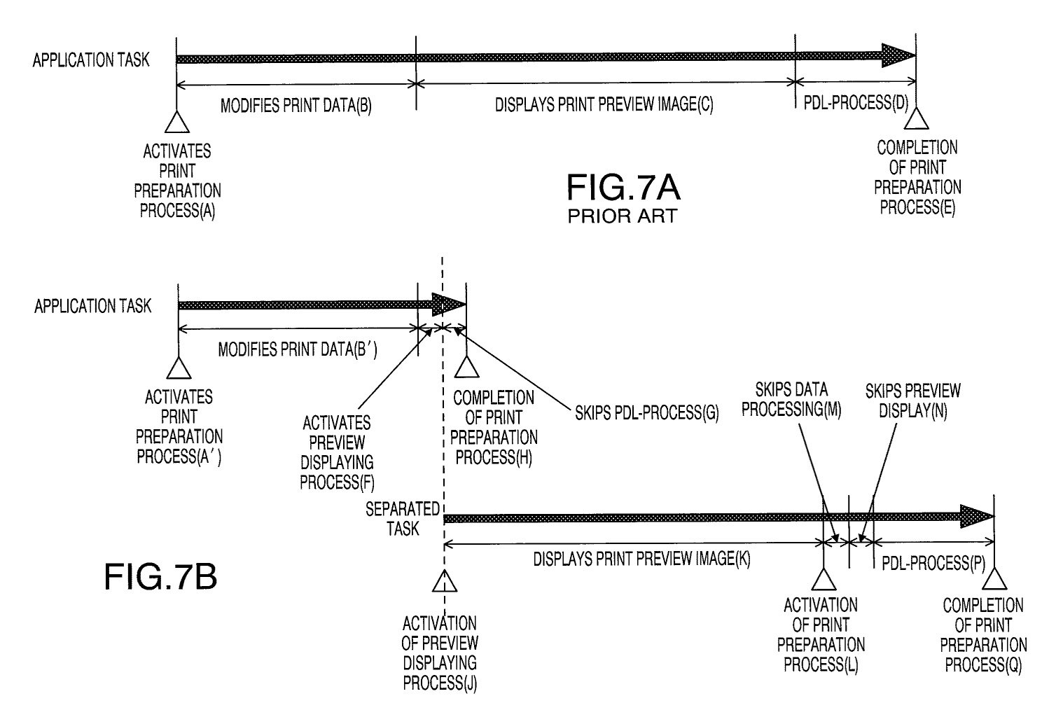

Next, the print preparation process according to the printer driver being executed in the separated operation task will be described with reference to FIGS. 7A and 7B. FIG. 7A is a diagram to illustrate a conventional print preparation process. FIG. 7B is a diagram to illustrate the print preparation process and the preview displaying process activated in a separated operation task according to the present embodiment.

In FIG. 7A, when the print preparation process starts at (A), a printer driver is activated and executed in a process included in a currently-executed operation task of the running application program. The printer driver converts the application data provided from the application program into a printable format in (B). Further, a print preview image is displayed in (C), and the application data is PDL-processed and transmitted to the printer in (D). The print preparation process is terminated thereafter at (E).

According to the present embodiment, as shown in FIG. 7B, the print preparation process is activated and executed in a process included in a currently-executed operation task of the running application program at (A′). The printer driver converts the application data provided from the application program into a printable format in (B′). Thereafter, the preview displaying process is activated in a separated operation task in (F), and the print preparation process is terminated at (H) without executing the PDL process or transmitting the print job data to the printer 10 in (G). Thus, after termination of the print preparation process according to the printer driver, the paused process in the preceding operation task for the application program can be resumed.

Further, the print preview image is displayed in the preview displaying process (J) activated in the separated operation task in (K). It is to be noted that active windows to display the preceding operation task of the resumed application program and the image according to the preview displaying process in the separated operation task can be switched from one to the other.

When the preview displaying process is terminated, the print preparation process is activated in the separated operation task at (L). By this point, the application data has been through the data processing such as the watermark applying process, the scaling process, and the multi-page arranging process; therefore, these steps are skipped in (M). Further the preview displaying is skipped in (N), and the print job data is PDL-processed and transmitted to the printer 10 in (P). The print preparation process is terminated at (Q).

It is to be noted, in the conventional configuration, when a print preview image for a current print preparation process is displayed, a next image cannot be processed in a new print preparation process. This is because the printer driver is capable of processing one print job at a time. According to the above configuration in the embodiment of the invention, however, specifically in activation of the preview displaying process in (F) and S1420 in FIG. 4, the previous print preparation process completes while the print preview image of the next print job data is displayed. Therefore, an image in the previous print job can be printed while the next print preview image is displayed.

Further, it is to be noted that, when the print job data is provided to the printer 10 through the network, the CPU 31 establishes communication with the printer 10 upon activation of the print preparation process. In the conventional configuration, however, the application data is transmitted to the printer 10 when the user views the print preview image and provides the print instruction for the application data thereafter. Therefore, when the user takes time to view the print preview image, and a predetermined time period elapsed, the printer may disconnect itself from the PC 30. In such a case, the image represented by the print preview image cannot be printed. According to the above embodiment, however, the PC 30 establishes connection with the printer 10 after display of the print preview image is completed (i.e., after S280). Therefore, the print job data can be transmitted to the printer 10 before a timeout.

Although an example of carrying out the invention has been described, those skilled in the art will appreciate that there are numerous variations and permutations of the print controlling device that fall within the spirit and scope of the invention as set forth in the appended claims. It is to be understood that the subject matter defined in the appended claims is not necessarily limited to the specific features or act described above. Rather, the specific features and acts described above are disclosed as example forms of implementing the claims.

What is claimed is:

1. A print controlling device operated on a multi-task operating system to process application data according to a printer driver, which is activated by the application program to be included in a currently-running operating task having executed a preceding process for the application program, whilst the preceding process for the application program in the currently-running operation task is paused, comprising:
an input device to input information to be processed in the print controlling device;
a display device to display the information inputted in the print controlling device;
a modifying system to modify the application data into a printable format;
a communication interface through which the printable-formatted data is transmitted to a printing device so that the image represented by the application data is printed;
an output device determining system to determine to which devices between the printing device and the display device the printable-formatted data is output;
an activating system to activate a displaying program in a separated operating task from the currently-executed operating task having been executed for the printer driver when the display device is selected by the output device determining system;
a transmission system to transmit the printable-formatted data to the printing device when the printing device is selected by the output device determining system; and
a terminating system to terminate the currently-running operating task for the printer driver when the activating system activates the displaying program in the separated operating task.

2. The print controlling device according to claim 1,
wherein the displaying program is configured to display the printable-formatted data in the display device to present a preview image, which represents an image to be printed by the printing device.

3. The print controlling device according to claim 2,
wherein the preview image is displayed along with a screen including a user interface device, through which a user can enter a print instruction to activate a printing operation;
wherein the printer driver is activated to be included in the separated operating task when the print instruction is entered through the user interface device; and
wherein the transmission system transmits the printable-formatted data corresponding to the preview image displayed by the display device to the printing device when the printer driver is activated by the print instruction entered through the user interface device.

4. The print controlling device according to claim 3,
wherein the modifying system is prevented from being activated when the printer driver is activated to be included in the separated operating task when the print instruction is entered through the user interface device.

5. The print controlling device according to claim 2,
wherein the preview image is displayed along with a screen including a user interface device, through which a user can enter a print instruction to activate a printing operation;
wherein the printer driver is activated to be included in the separated operating task when the user interface device remains unoperated for a predetermined time period; and
wherein the transmission system transmits the printable-formatted data corresponding to the preview image displayed by the display device to the printing device when the printer driver is activated without the user's operation to the user interface device.

6. A method to control a computer operated on a multi-task operating system to process application data according to a printer driver, which is activated by the application program to be included in a currently-running operating task having executed a preceding process for the application program, whilst the preceding process for the application program in the currently-running operation task is paused, comprising:
converting the application data into a printable format;
determining to which devices between a printing device and a display device, which are connected with the computer, the printable-formatted data is output;
activating a displaying program in a separated operating task from the currently-executed operating task having been executed for the printer driver when the display device is determined to be the one to which the printable-formatted data is output;
transmitting the printable-formatted data to the printing device when the printing device is s determined to be the one to which the printable-formatted data is output; and
terminating the currently-running operating task for the printer driver when the displaying program is activated in the separated operating task.

7. A computer usable medium comprising computer readable instructions to control a computer operated on a multi-task operating system to process application data according to a printer driver, which is activated by the application program to be included in a currently-running operating task having executed a preceding process for the application program, whilst the preceding process for the application program in the currently-running operation task is paused, by executing steps of:
converting the application data into a printable format;
determining to which devices between a printing device and a display device, which are connected with the computer, the printable-formatted data is output;
activating a displaying program in a separated operating task from the currently-executed operating task having been executed for the printer driver when the display device is determined to be the one to which the printable-formatted data is output;
transmitting the printable-formatted data to the printing device when the printing device is s determined to be the one to which the printable-formatted data is output; and
terminating the currently-running operating task for the printer driver when the displaying program is activated in the separated operating task.

8. A method to control a print preparing operation according to a print preparation program, which includes a printer driver and a displaying program, in a computer operated on a multi-task operating system to process application data according to the printer driver, which is activated by the application program to be included in a currently-running operating task having executed a preceding process for the application program, whilst the preceding process for the application program in the currently-running operation task is paused,
wherein the printer driver includes steps of:
converting the application data into a printable format;
determining to which devices between a printing device and a display device, which are connected with the computer, the printable-formatted data is output;
activating the displaying program in a separated operating task from the currently-executed operating task having been executed for the printer driver when the display device is determined to be the one to which the printable-formatted data is output;
transmitting the printable-formatted data to the printing device when the printing device is s determined to be the one to which the printable-formatted data is output; and
terminating the currently-running operating task for the printer driver when the displaying program is activated in the separated operating task; and
wherein the displaying program is configured to display the printable-formatted data in the display device to present a preview image, which represents an image to be printed by the printing device.

9. A computer usable medium comprising computer readable instructions to control a print preparing operation according to a print preparation program, which includes a printer driver and a displaying program, in a computer operated on a multi-task operating system to process application data according to the printer driver, which is activated by the application program to be included in a currently-running operating task having executed a preceding process for the application program, whilst the preceding process for the application program in the currently-running operation task is paused,
wherein the printer driver includes steps of:
converting the application data into a printable format;
determining to which devices between a printing device and a display device, which are connected with the computer, the printable-formatted data is output;
activating the displaying program in a separated operating task from the currently-executed operating task having been executed for the printer driver when the display device is determined to be the one to which the printable-formatted data is output;
transmitting the printable-formatted data to the printing device when the printing device is s determined to be the one to which the printable-formatted data is output; and
terminating the currently-running operating task for the printer driver when the displaying program is activated in the separated operating task; and
wherein the displaying program is configured to display the printable-formatted data in the display device to present a preview image, which represents an image to be printed by the printing device.
